(19) United States
(12) Patent Application Publication
(10) Pub. No.: US 2013/0089740 A1
(43) Pub. Date: Apr. 11, 2013

(54) SYNTHESIS AND USE OF IRON OLEATE

(71) Applicants: Dirk Burdinski, Essen (DE); Carmen Bohlender, Jena (DE)

(72) Inventors: Dirk Burdinski, Essen (DE); Carmen Bohlender, Jena (DE)

(73) Assignee: KONINKLIJKE PHILIPS ELECTRONICS N.V., EINDHOVEN (NL)

(21) Appl. No.: 13/805,948

(22) PCT Filed: Jun. 21, 2011
(86) PCT No.: PCT/IB2011/052708

§ 371 Date: Dec. 20, 2012

(30) Foreign Application Priority Data
Jun. 29, 2010 (EP) 10167687.2

(51) Int. Cl. C07F 15/02; C01G 49/02

(52) U.S. Cl. CPC C07F 15/025; C01G 49/02; Y10S 977/896; B82Y 40/00
USPC 428/402.24; 554/74; 423/632; 977/896

(57) ABSTRACT

The present invention relates to a method of forming an iron oleate complex comprising the steps of: (a) dissolving an oleate in a low-order alcohol solvent at a temperature of about 35° C. to 65° C.; (b) adding a non-polar solvent to the solution of step (a); (c) adding an iron salt dissolved in a low-order alcohol to the solution of step (b); (d) agitating the solution of step (c) at a temperature of about 50° C. for at least 5 min; (e) cooling the reaction mixture of step (d) to a temperature of about 15° C. to 30° C.; (f) optionally filtering the reaction mixture of step (e); (g) separating the non-polar solvent phase from the low-order alcohol phase; (h) washing and drying the non-polar solvent phase; (i) removing volatiles from the non-polar solvent phase of step (h) by evaporation; and (j) mixing the product of step (i) with a polar solvent to yield a solid iron oleate complex. The present invention further relates to an iron oleate complex obtainable by the method of the invention, an iron oleate complex of formula I, the use of the iron oleate complex of the invention as precursor for the preparation of nanoparticles, and a method of forming iron oxide nanoparticles comprising the suspension of iron oxide/hydroxide and the iron oleate complex of the invention.

### FIELD OF THE INVENTION

The present invention relates to a method of forming an iron oleate complex comprising the steps of: (a) dissolving an oleate in a low-order alcohol solvent at a temperature of about 35° C. to 65° C.; (b) adding a non-polar solvent to the solution of step (a); (c) adding an iron salt dissolved in a low-order alcohol to the solution of step (b); (d) agitating the solution of step (c) at a temperature of about 50° C. for at least 5 min; (e) cooling the reaction mixture of step (d) to a temperature of about 15° C. to 30° C.; (f) optionally filtering the reaction mixture of step (e); (g) separating the non-polar solvent phase from the low-order alcohol phase; (h) washing and drying the non-polar solvent phase; (i) removing volatiles from the non-polar solvent phase of step (h) by evaporation; and (j) mixing the product of step (i) with a polar solvent to yield a solid iron oleate complex. The present invention further relates to an iron oleate complex obtainable by the method of the invention, an iron oleate complex of formula I, the use of the iron oleate complex of the invention as precursor for the preparation of nanoparticles, and a method of forming iron oxide nanoparticles comprising the suspension of iron oxide/hydroxide and the iron oleate complex of the invention.

### BACKGROUND OF THE INVENTION

Magnetic Particle Imaging (MPI) is a tomographic imaging technique which relies on the nonlinearity of the magnetization curves of ferromagnetic nanoparticles and the fact that the particle magnetization saturates at some magnetic field strength. In a medical context MPI uses the magnetic properties of ferromagnetic nanoparticles injected into the body to measure the nanoparticle concentration, e.g. in the blood. Because a body contains no naturally occurring magnetic materials visible to MPI, there is no background signal, whereas in classical Magnetic Resonance Imaging (MRI) approaches the thresholds for in vitro and in vivo imaging are such that the background signal from the host tissue is a crucial limiting factor. After injection, the MPI nanoparticles appear as bright signals in the images, from which nanoparticle concentrations can be calculated. By combining high spatial resolution with short image acquisition times, MPI can capture dynamic concentration changes as the nanoparticles are swept along by the blood stream. This allows MPI scanners to perform a wide range of functional measurements in a single scan.

A spectrometric variant of MPI is Magnetic Particle Spectroscopy (MPS) which is a zero-dimensional magnetic particle imaging approach. MPS provides remagnetization signals without reconstructing images and accordingly is an efficient way of characterizing the absolute response of magnetic particles when they are exposed to an oscillating magnetic field. MPS is thus closely linked to MPI and particle properties measured by MPS are characteristic for the performance of these particles as tracers for MPI.

An important aspect of MPI is the provision of suitable magnetic material, i.e. of magnetic nanoparticle tracers which can effectively be detected. However, up to now, no dedicated MPI tracer material has become commercially available.

The suitability of the magnetic material is intimately linked to its remagnetization properties. The remagnetization of magnetic nanoparticle traces depends on a number of parameters, most importantly on the composition of the magnetic material itself, its volume and anisotropy, and its particle size distribution. Due to toxicological reasoning and the experience in Magnetic Resonance Imaging applications, superparamagnetic particles of iron oxide (SIPOs) appear to be a material of choice for the development of MPI tracers. Since the MPS signal intensity increases with the size of the iron oxide particles, a useful signal is only obtained with particles having a magnetic core of larger than ca. 15 nm.

Furthermore, the particles should be monodisperse and should possess a small magnetic anisotropy constant of <2 kJ/m³ to be able to follow the fast remagnetization with a frequency of about 25 kHz. Thus, an iron oxide nanoparticle to be effective in MPI has to show a very narrow size distribution, a very good shape control and the potential for easy upscaling. Furthermore, the particle should be water-soluble.

Methods for the production of SIPOs are known in the art. Among these, in general, four synthetic strategies can be distinguished: thermal decomposition methods, hydrothermal synthesis methods, co-precipitation methods and microemulsion techniques. For SIPOs to be usable in MPI thermal decomposition is the synthesis method of choice.

Thermal decomposition, in general, entails the decomposition of suitable precursor molecules. The most commonly used precursors for the synthesis of iron oxide nanoparticles are iron oleate complexes, as described by Park et al., Nature Materials, 2004, 3, 891-895. However, iron oleate precursors are mostly ill-defined and no details of their synthesis are provided.

There is thus a need for a well defined iron oleate precursor material that can be prepared in a controlled and reproducible way.

### SUMMARY OF THE INVENTION

The present invention addresses this need and provides means and methods which allow the synthesis of improved iron oleate precursor material, which can be used for the production of magnetic nanoparticles. The above objective is in particular accomplished by a method comprising the steps of:

(a) dissolving an oleate in a low-order alcohol solvent at a temperature of about 35° C. to 65° C.;

(b) adding a non-polar solvent to the solution of step (a);

(c) adding an iron salt dissolved in a low-order alcohol solvent to the solution of step (b);

(d) agitating the solution of step (c) at a temperature of about 50° C. for at least 5 min;

(e) cooling the reaction mixture of step (d) to a temperature of about 15° C. to 30° C.;

(f) optionally filtering the reaction mixture of step (e);

(g) separating the non-polar solvent phase from the low-order alcohol solvent phase;

(h) washing and drying the non-polar solvent phase;

(i) removing volatiles from the non-polar solvent of step (h) by evaporation; and

(j) mixing the product of step (i) with a polar solvent to yield a solid iron oleate complex.

This method provides the advantageous feature of being straight-forward and time-efficient. It is, furthermore, highly reproducible and the produced iron oleate complex has a well-defined composition. The solid material is, in addition, easy to store and to use, allowing the efficient production of particles or contrast agents for Magnetic Resonance Imaging (MPI) and, in particle, Magnetic Particle Imaging (MPI).

In a preferred embodiment of the present invention the temperature of dissolving step (a) is at about 50° C.

In a further preferred embodiment said oleate is sodium oleate. Additionally or alternatively, in a further preferred embodiment, said low-order alcohol solvent is methanol. Additionally or alternatively, in a further preferred embodiment, said non-polar solvent is hexane. Additionally or alternatively, in a further preferred embodiment, said polar solvent is acetone. Additionally or alternatively, in a further preferred embodiment, said iron salt is iron chloride. Particularly preferred is the use of iron(III) chloride (FeCl₃).

In yet another preferred embodiment the method as mentioned above is carried out with an excess of sodium oleate.

In a particularly preferred embodiment of the present invention a sodium oleate:FeCl₃ molar ratio of 3:1 is used.

In another preferred embodiment of the present invention said mixing step (j) as mentioned above is carried out for about 1 h to 10 h.

In a further preferred embodiment of the present invention one or more of the additional steps

(k) isolating the solid iron oleate complex by filtration;

(l) washing the solid iron oleate complex of step (j) or (k) with a polar solvent;

(m) dissolving the solid iron oleate complex of step (l) in a non-polar solvent;

(n) filtering the solid iron oleate complex of step (m);

(o) adding to the solid iron oleate complex of step (n) an excess of a polar solvent;

(p) stirring the suspension of step (o) for about 1 to 10 h;

(q) filtering the iron oleate complex;

(r) washing the iron oleate complex of step (q) with a polar solvent; and

(s) drying the iron oleate complex of step (r) to yield a powdery solid iron oleate complex, is performed.

In a further, particularly preferred embodiment of the present invention in step (o) as mentioned above an excess of acetone is added. Particularly preferred is the use of an excess of at least 4:1.

In a further aspect the present invention relates to an iron oleate complex obtainable by a method as defined herein above.

In a yet another aspect the present invention relates to an iron oleate complex of formula I:

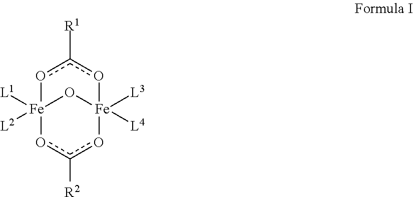

In a preferred embodiment in said iron oleate complex R¹ and R² is (CH₂)₇(CH)═(CH)(CH₂)₇CH₃ and L¹, L², L³ and L⁴ are auxiliary ligands.

In a further preferred embodiment said auxiliary ligands L¹, L², L³ and L⁴ are independent of each other acetone, methanol, ethanol, water, tetrahydrofurane, imidazole, methylimidazole, pyridine, formamide, dimethylformamide, pyrolidon, 1-methyl-2-pyrolidon, hydroxide, fluoride, chloride, bromide, iodide, sulfate, bisulfate, phosphate, biphosphate, nitrate, sulfide, bisulfide, oxalate, lactate, cyanide, cyanate, isocyanate, thiocyanate, isothiocyanate, acetylacetonate, carbonate, bicarbonate, azide, benzoate, acrylate, methacrylate, sulfite, bisulfite, methoxide, ethoxide, cyclohexanesulfonate, methanesulfonate, ethanesulfonate, propanesulfonate, pentanesulfonate, hexanesulfonate, octanesulfonate, decanesulfonate, dodecanesulfonate, octadecanesulfonate, citrate, tartrate, borate, hydrogen borate, dihydrogen borate, nitrite, perborate, peroxide, thiosulfate, methionate, acetate, propionate, butyrate, pentanoate, hexanoate, heptanoate, octanoate, decanoate, dodecanoate, pentadecanoate, hexadecanoate, octadecanoate, or oleate.

In a particularly preferred embodiment said auxiliary ligands L¹, L², L³ and/or L⁴ are hydroxide or acetone.

In a further preferred embodiment said iron oleate complex of the present invention has the molecular formula Fe₂O(oa)₂(OH)₂(OC(CH₃)₂)₂.

In another aspect the present invention relates to the use of the iron oleate complex as defined herein above, or the iron oleate complex as obtainable by a method as mentioned herein above, as precursor for the preparation of nanoparticles.

In another aspect the present invention relates to a method of forming iron oxide nanoparticles comprising the steps of:

(a) suspending oleic acid and the iron oleate complex as defined herein above, or the iron oleate complex obtainable by a method of the present invention as mentioned herein above, and optionally oleylamine, in a primary organic solvent;

(b) increasing the temperature of the suspension by a defined rate up to a maximum of 340° C. to 500° C.;

(c) aging the suspension at the maximum temperature of step (b) for about 0.5 to 6 h;

(d) cooling the suspension;

(e) adding a secondary organic solvent;

(f) precipitating nanoparticles by adding a non-solvent and removing excess solvent;

(g) dispersing said nanoparticles in said secondary organic solvent;

(h) mixing the dispersion of step (g) with a solution of a polymer; and

(i) optionally removing said secondary organic solvent.

In a preferred embodiment of the present invention said above mentioned method of forming iron oxide nanoparticles comprises one or more of the additional steps

(j) purifying the nanoparticle or nanoparticle solution obtainable in step (i);

(k) treating the nanoparticle or nanoparticle solution obtainable in step (i) or (j) with an oxidizing or reducing agent;

(l) modifying the surface of the nanoparticle obtainable in step (i) or (j) by removing, replacing or altering the coating;

(m) encapsulating or clustering the nanoparticle obtainable in step (i) to (l) with a carrier such as a micelle, a liposome, a polymersome, a blood cell, a polymer capsule, a dendrimer, a polymer, or a hydrogel; and

(n) decorating the nanoparticle obtainable in step (i) to (m) with a targeting ligand.

### BRIEF DESCRIPTION OF THE DRAWINGS

FIG. 1 shows the constitutional formula of an oleate anion (oa).

FIG. 2 depicts a Fourier-transform infrared spectrum of an iron oleate obtained according to the method of the present invention, which is measured as attenuated total reflection.

FIG. 3 shows transmission electron microscopy (TEM) images of iron oxide nanoparticles (after drying on a holey carbon film) obtained after thermal decomposition of iron oleate in icosane (sample 11). The average particle size is about 18 nm.

FIG. 4 shows a vibrating sample magnetometry spectrum of sample 11, a solution of iron oxide nanoparticles in hexane with a total iron concentration of 0.90 mg(Fe)/ml, as obtained upon thermal decomposition of iron oleate in icosane. The Fit parameters are: d₀=15.3 nm, σ=0.17, M_{S}=47.9 emu/g.

FIG. 5 depicts Magnetic Particle Spectroscopy (MPS) results of two samples: a) Resovist® (Bayer Schering Pharma), a solution of iron oxide nanoparticles in aqueous buffer solution with a total iron concentration of 28 mg (Fe)/ml (indicated as open circles); and b) sample 11, a solution of iron oxide nanoparticles in hexane with a total iron concentration of 0.90 mg(Fe)/ml, as obtained upon thermal decomposition of iron oleate in icosane (iron oleate, oleic acid, and icosane in a mass ratio of 1:4.4:6) (indicated as closed circles). All spectra were normalized with respect to the iron content for direct comparability.

FIG. 6 depicts Magnetic Particle Spectroscopy (MPS) results of three samples as relative intensities: a) Resovist® (Bayer Schering Pharma), a solution of iron oxide nanoparticles in aqueous buffer solution (indicated as open circles); b) sample 12, a solution of iron oxide nanoparticles in hexane, as obtained upon thermal decomposition of iron oleate in icosane (iron oleate, oleic acid, and icosane in a mass ratio of 1:6.8:6) (indicated as closed circles); and c) sample 13, a solution of iron oxide nanoparticles in hexane, as obtained upon thermal decomposition of iron oleate in icosane (iron oleate, oleic acid, and icosane in a mass ration of 1:5.6:6) (indicated as closed triangles).

### DETAILED DESCRIPTION OF EMBODIMENTS

The inventors have developed means and methods which allow the synthesis of an improved iron oleate precursor material, which can be used for the production of magnetic nanoparticles. These nanoparticles are suitable as MPI, MPS or MRI tracers.

Although the present invention will be described with respect to particular embodiments, this description is not to be construed in a limiting sense.

Before describing in detail exemplary embodiments of the present invention, definitions important for understanding the present invention are given.

As used in this specification and in the appended claims, the singular forms of “a” and “an” also include the respective plurals unless the context clearly dictates otherwise.

In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%.

It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

In case the terms “first”, “second”, “third” or “(a)”, “(b)”, “(c)”, “(d)” etc. relate to steps of a method or use there is no time or time interval coherence between the steps, i.e. the steps may be carried out simultaneously or there may be time intervals of seconds, minutes, hours, days, weeks, months or even years between such steps, unless otherwise indicated in the application as set forth herein above or below.

It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

As has been set out above, the present invention concerns in one aspect a method of forming an iron oleate complex comprising the steps of

(a) dissolving an oleate in a low-order alcohol solvent at a temperature of about 35° C. to 65° C.;

(b) adding a non-polar solvent to the solution of step (a);

(c) adding an iron salt dissolved in a low-order alcohol solvent to the solution of step (b);

(d) agitating the solution of step (c) at a temperature of about 50° C. for at least 5 min;

(e) cooling the reaction mixture of step (d) to a temperature of about 15° C. to 30° C.;

(f) optionally filtering the reaction mixture of step (e);

(g) separating the non-polar solvent phase from the low-order alcohol solvent phase;

(h) washing and drying the non-polar solvent phase;

(i) removing volatiles from the non-polar solvent of step (h) by evaporation; and

(j) mixing the product of step (i) with a polar solvent to yield a solid iron oleate complex.

The initial step of the synthesis is the dissolving of an oleate in a solvent. An “oleate” as used herein is a salt of the oleic acid. Examples of oleates to be used in the context of the present invention are sodium oleate, potassium oleate, lithium oleate, rubidium oleate, caesium oleate. Furthermore any other salt of oleic acid may be used. A particularly preferred oleate is sodium oleate. The amount of oleate to be employed for the synthesis may be chosen according to the envisaged amount of iron oleate, the size of the reaction vessels, the amount of solvent to be used, the ratio of HOA:Fe etc.

As solvent any suitable organic solvent may be used. Preferred is the use of a low-order alcohol solvent. Preferred examples of low-order alcohol solvents comprise methanol, ethanol, propanol, isopropanol, butanol, glycol, acetone, ethyleneglycol, 2-aminoethanol, 2-methoxyethanol, dimthylformamide or dimethylsulfoxide or any mixture thereof. Particularly preferred is the use of methanol. The amount of solvent for the dissolving step may be adjusted to the amount of oleate to be dissolved. For example, an amount of solvent of once, twice, 3 times, 4 times, 5 times, 6 times, 7 times, 8 times, 9 times, 10 times, 15 times, 20 times, 30 times, 50 times, or 100 times the volume or weight of the oleate to be dissolved may be used.

The dissolving may be carried out according to any suitable technique, e.g. by stirring the oleate in the solvent, shaking of the reaction mixture, rotating movements etc. The dissolving step may be performed until the oleate salt is entirely dissolved, e.g. until no oleate salt precipitate is optically detectable. The dissolving step may be carried out, for example, for 1 min, 2 min, 5 min, 10 min, 20 min, 30 min, 45 min or 60 min.

The dissolving step may be carried out at a temperature of about 35° C. to 65° C., e.g. at about 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C. or 65° C. The temperature may further be lowered to about 25° C. or increased to about 75° C. During the dissolving step the temperature may be kept constant, e.g. at any of the above indicated levels, or may be varied. For instance, the temperature may first be set to a lower level, e.g. about 35° C., and subsequently be increased, e.g. up to about 50° C., 55° C., 60° C. or 65° C. Alternatively, the temperature may first be set to a higher level, e.g. to about 50° C., 55° C., 60° C., or 65° C., and subsequently be decreased, e.g. down to 35° C., 40° C. or 45° C. Furthermore, temperature profiles of combined increases and decreases in various sequences may be used, e.g. first a decrease, followed by an increase and finally a decrease etc.

In a further step of the synthesis a non-polar solvent is added to the solution of the step (a). A preferred group of non-polar solvents is the group of alkane solvents. Preferred examples or alkane solvents are hexane, butane, pentane, heptane or octane, as well as isoforms or derivatives thereof. Particularly preferred is the use of hexane. The hexane may be an n-hexane, or an iso-hexane, e.g. 2-methylpentane, 3-methylpentane, or 2,3-dimethylbutane, or a neo-hexane, e.g. 2,2-dimethylbutane.

The amount of non-polar solvent to be employed may be chosen according to the amount, weight and/or volume of the mixture obtained in step (a). Preferably, the non-polar solvent is added in an amount of once, twice, 3 times, 4 times, 5 times, 6 times, 7 times, 8 times, 9 times, 10 times, 15 times, 20 times, 30 times, 50 times, or 100 times the volume or weight of the mixture obtained in step (a). The solution may be added in any suitable temperature, e.g. at room temperature. Alternatively, the solution may be set to the temperature of the reaction mixture of step (a).

In a further step of the synthesis an iron salt is added. Preferably, an iron salt with iron in the +2, +3 or +4 oxidation state, more preferably in the +2 or +3 oxidation state is added. A further preferred compound to be added is an iron (II) or iron (III) salt. Particularly preferred is the use of iron chloride, e.g. iron (II) chloride (FeCl₂) or iron (III) chloride (FeCl₃). Alternatively, iron fluoride, iron bromide, or iron iodide may be used. Furthermore, any combination of the mentioned iron compounds in any stoichiometry may be used. The iron compound may be added as such to the reaction mixture of step (b), or may be added in dissolved form. Preferably a dissolved iron compound is provided. The iron compound may, for example, be dissolved in an organic solvent. Preferred is the use of a low-order alcohol. More preferred is the employment of methanol. Alternatively, ethanol, propanol, isopropanol, butanol, glycol, acetone, ethyleneglycol, 2-aminoethanol, 2-methoxyethanol, dimthylformamide or dimethylsulfoxide or any mixture thereof may be used.

The amount of iron compound, e.g. iron salt or iron in the +2, +3 or +4 oxidation state to be added may be chosen according to the envisaged amount of iron oleate, and/or the amount of oleate used for step (a) of the synthesis. For example, the iron compound may be added in a molar ratio of 1:1, 1:2, 1:3, 1:4, 1:5, 1:7, 1:8, 1:9 or 1:10 etc., or 2:1, 3:1: 4:1, 5:1, 6:1, 7:1, 8:1, 9:1, 10:1 etc., or 2:3, 2:5, 2:7, 2:9 etc., or 3:2, 5:2, 7:2, 9:2 etc. of the iron compound vs. the oleate.

The iron compound or iron compound solution as mentioned above may be added having any suitable temperature, e.g. having room temperature. Alternatively, the temperature of the solution may be set to the temperature of the reaction mixture of step (a).

In a further step of the synthesis the solution of step (c) may be agitated. The agitation may be carried out according to any suitable method known to the person skilled in the art, e.g. by stirring the reaction mixture, shaking the reaction mixture, rotating movements etc.

Preferably, the agitation is carried out at a temperature of about 35° C. to 65° C. The agitation may, for example, be carried out at 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C. or 65° C. Particularly preferred is an agitation at about 50° C.

The agitation may be carried out for at least about 5 minutes. For example, the agitation may be carried out for about 5 min, 10 min, 15 min, 20 min, 25 min, 30 min, 35 min, 40 min, 45 min, 50 min, 55 min, 60 min, 65 min, 70 min, 75 min, 80 min, 85 min, 90 min, 2 h, 3 h or more than 3 h.

In a further step of the synthesis the reaction mixture of step (d) is cooled down. The cooling may be carried out by using suitable cooling equipment, or by a transfer to a suitably cooled environment. Preferably, the reaction mixture is cooled to a temperature of about 10° C. to 35° C., more preferably to a temperature of about 15° C. to 30° C. The reaction mixture may, for example, be cooled to a temperature of about 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., or 35° C. Alternatively, the reaction mixture may be cooled to room temperature.

The cooling may be performed by an immediate temperature change, e.g. to any of the above indicated temperatures. Alternatively, the cooling may be carried out gradually, e.g. by decreasing the temperature of the reaction mixture of step (d) by 1, 2, 3, 4, 5, 6, 7, 8, 9, 10, 15 or 20° C. per minute, per 2 minutes, per 5 minutes, per 10 minutes or per 20 minutes.

In a further, optional step of the synthesis the reaction mixture of step (e) is filtered. The filtering step may be added in dependence of the condition of the reaction mixture of step (d) or (e), e.g. in dependence of the viscosity of the reaction mixture, the amount of precipitated material in the reaction mixture etc. Particularly preferred is the filtration in dependence of the presence and/or amount of precipitated material in order to improve the subsequent synthesis steps. The filtration may be carried out according to any suitable method, e.g. by employing dynamic filtration like microfiltration, ultrafiltration, nanofiltration, reverse osmosis, or by using static filtration such as vacuum filtration, pressure filtration or membrane filtration etc. Furthermore, molecular sieves may be employed. The filtration may preferably be used to separate particles larger than 5 nm.

In a further step of the synthesis the organic solvent phase of step (a), preferably the low-order alcohol solvent phase, more preferably the methanol phase of step (a), is separated from the non-polar solvent phase of step (b), preferably the alkane phase, more preferably the hexane phase. The separation may preferably be carried out as liquid-liquid extraction or solvent extraction based on the different solubilities of the solvent of step (a) and the non-polar solvent of step (b). Any suitable method of solvent extraction known to the person skilled in the art may be used. Typically a reparatory funnel is used. The organic solvent phase, preferably the low-order alcohol solvent phase, more preferably the methanol phase may subsequently be discarded and further synthesis steps may be carried out with the non-polar phase, preferably the hexane phase.

In a further step of the synthesis the non-polar phase, preferably the alkane phase, more preferably the hexane phase is washed. The washing may be carried out with an organic solvent as mentioned herein above. Preferably, a low-order alcohol solvent, more preferably a methanol solvent may be used for the washing step. The washing step preferably comprises an agitation or stirring step, wherein both phases are mixed. The washing step furthermore includes an additional separation step as defined herein above. Accordingly, the washing phase, e.g. the methanol phase, is discarded, whereas the non-polar, e.g. the hexane phase, is used for further washing and/or synthesis steps. The washing may be repeated once, twice, 3 times, 4 times or more often. Preferably, the washing is repeated until the washing phase, e.g. the methanol phase, does not change its color, preferably remains colorless.

In a particular embodiment of the present invention the washing step as defined herein above may be skipped. Such a skipping may preferably be envisaged in case the organic solvent or low-order alcohol solvent, e.g. the methanol phase, is essentially colorless or shows only minor impurities.

Subsequently the remaining non-polar phase, e.g. the alkane or hexane phase is dried. The term “drying” as used herein refers to the removal of water or polar solvents from the non-polar phase. For the drying process any suitable process known to the person skilled in the art, preferably any suitable hygroscopic material may be used. Examples of such hygroscopic material are glycerol, sulfuric acid, phosphor oxides and salts. Particularly preferred is the employment of magnesium salts, e.g. Mg₂SO₄, or sodium salts, e.g. Na₂SO₄. The drying step is preferably performed until essentially all water or polar solvent components are removed from the non-polar phase.

In a particular embodiment of the present invention the drying step as defined herein above may be skipped. Such a skipping may preferably be envisaged in case the non-polar phase, e.g. the alkane or hexane phase, is essentially dry or shows only a minor of degree of moisture.

In a further, optional step of the synthesis the reaction mixture of step (h) is filtered. The filtering step may be added in dependence of the condition of the reaction mixture of step (h), e.g. in dependence of the viscosity of the reaction mixture, the amount of precipitated material in the reaction mixture etc. In case a hygroscopic material such as magnesium salts, e.g. Mg₂SO₄, or sodium salts, e.g. Na₂SO₄ is used a filtration step may preferably be carried out in order to remove said hygroscopic material. The filtration may be carried out according to any suitable method, e.g. by employing dynamic filtration like microfiltration, ultrafiltration, nanofiltration, reverse osmosis, or by using static filtration such as vacuum filtration, pressure filtration or membrane filtration etc. Furthermore, molecular sieves may be employed. The filtration may preferably be used to separate particles larger than 5 nm.

In a further step of the synthesis the volatile portion of the reaction mixture is removed. The removal may preferably be carried out by evaporation. Generally, evaporation is a type of vaporization of a liquid, that occurs only on the surface of a liquid and thus constitutes a phase transition, i.e. a process by which molecules in a liquid state spontaneously become gaseous. Evaporation may be understood as gradual disappearance of a liquid from a substance when exposed to a significant volume of gas. Accordingly, the evaporation step may be performed by increasing the surface of the reaction mixture, e.g. by employing suitable reaction vessels or by agitating the reaction mixture. Additionally or alternatively, the gaseous space or areal in contact with the liquid reaction mixture may be altered by ventilation or gas exchange step in order to reduce the concentration of volatiles in said space or areal. Furthermore, the pressure or pressure conditions in the reaction room or chamber may be suitably adjusted. Preferably, said evaporation step may be performed until a viscous oil is obtained.

In yet another, further step of the synthesis the product of step (i) is mixed with a suitable polar solvent. Preferably, said polar solvent is an aqueous polar solvent. Further preferred is the employment of a non-protic polar solvent. Suitable examples of polar solvents to be used in the context of the present invention are acetone, 2-butanone, 2-pentanone, isobutyl methyl ketone, tetrahydrofurane, diethylether or diisopropylether. Preferred is the use of acetone. The mixing is carried out by agitation as defined herein above. The amount of solvent for the mixing step may be adjusted to the amount of product of step (i). For example, an amount of solvent of once, twice, 3 times, 4 times, 5 times, 6 times, 7 times, 8 times, 9 times, 10 times, 15 times, 20 times, 30 times, 50 times, or 100 times the volume or weight of the product of step (i) may be used.

The mixing may be performed for any suitable period of time, e.g. for about 30 min to 24 h, preferably for about 45 min to 18 h, more preferably for about 1 h to 14 h. The mixing may preferably be carried out to yield a solid iron oleate. The term “solid iron oleate” as used herein refers to a non-liquid precipitate, preferably of red-brown color.

In a particularly preferred embodiment of the present invention the temperature of dissolving step (a) of the method as mentioned herein above is at about 50° C. The temperature may, for example, be 48° C., 48.5° C., 49° C., 49.1° C., 49.2° C., 49.3° C., 49.4° C., 49.5° C., 49.6° C., 49.7° C., 49.8° C., 49.9° C., 50° C., 50.1° C., 50.2° C., 50.3° C., 50.4° C., 50.5° C., 50.6° C., 50.7° C., 50.8° C., 50.9° C. or 51° C., 51.5° C. or 52° C. In a further embodiment, said temperature may initially be used and/or may be kept constant. Alternatively, said temperature may be varied, e.g. by arriving at said temperature by an increase of the temperature by 1, 2, 3, 4, 5, 6, 7, 8, 9, 10, 15 or 20° C. per minute, per 2 minutes, per 5 minutes, per 10 minutes or per 20 minutes.

In a further, particularly preferred embodiment of the present invention sodium oleate is employed. Additionally or alternatively, as low-order alcohol solvent methanol is used. Particularly preferred is the employment of sodium oleate together with methanol. Additionally or alternatively, as non-polar solvent hexane is used. Particularly preferred is the employment of sodium oleate together with methanol as low-order alcohol solvent and hexane as non-polar solvent. Additionally or alternatively, as polar solvent acetone is used. Particularly preferred is the employment of sodium oleate together with methanol as low-order alcohol solvent, hexane as non-polar solvent and acetone as polar solvent. Additionally or alternatively, iron chloride is used as iron salt.

In a further, particularly preferred embodiment of the present invention said iron chloride to be added in step (c) of the method of the present invention is iron(III) chloride, i.e. FeCl₃. Alternatively, a mixture of iron (II) chloride (FeCl₂) and iron (III) chloride (FeCl₃) may be employed.

In a further preferred embodiment of the present invention an excess of oleate, preferably of sodium oleate, with respect to the iron compound, in particular with respect to the iron chloride, more preferably with respect to FeCl₃ may be used. The term “excess of sodium oleate” as used herein refers to the molar amount or weight of sodium oleate which surpasses the molar amount or weight of the iron compound, in particular of the iron chloride, e.g. FeCl₃. The excess of oleate, preferably of sodium oleate, may be in a ratio of 2:1, 3:1, 4:1, 5:1, 6:1, 7:1, 8:1, 9:1, 10:1, 11:1, 15:1, 20:1, 25:1, 30:1, 50:1, 100:1 etc., or 3:2, 5:2, 7:2, 9:2, 11:2, 13:2, 15:2, 17:2, 25:2, 45:2, 75:2 etc. or any other ratio between the oleate, preferably the sodium oleate and the iron compound.

In a particularly preferred embodiment of the present invention a sodium oleate:FeCl₃ molar ratio of 3:1 is used.

In a further, particularly preferred embodiment of the invention the mixing step (j) of the method as mentioned above is carried out for about 1 to 10 h. For example, the mixing may be carried out for 1 h, 1.5 h, 2 h, 2.5 h, 3 h, 3.5 h, 4 h, 4.5 h, 5 h, 5.5 h, 6 h, 6.5 h, 7 h, 7.5 h, 8 h, 8.5 h, 9 h, 9.5 h or 10 h. The mixing step may further be carried out for any period of time between these values. The suitable period of time may further be determined according to the condition of the solid iron oleate and/or the condition of the reaction mixture, e.g. the proportion of solid iron oleate in comparison to the overall volume of the reaction mixture, or the color and/or viscosity of the reaction mixture.

In a yet another embodiment of the present invention one or more additional steps of the method as defined herein above may be carried out. These steps may additionally be carried out or skipped according to necessities, e.g. in dependence of the purity of the obtained iron oleate, the envisaged use of the iron oleate etc. These steps preferably include:

(k) isolating the solid iron oleate complex by filtration;

(l) washing the solid iron oleate complex of step (j) or (k) with a polar solvent;

(m) dissolving the solid iron oleate complex of step (l) in a non-polar solvent;

(n) filtering the solid iron oleate complex of step (m);

(o) adding to the solid iron oleate complex of step (n) an excess of a polar solvent;

(p) stirring the suspension of step (o) for about 1 to 10 h;

(q) filtering the iron oleate complex;

(r) washing the iron oleate complex of step (q) with a polar solvent; and

(s) drying the iron oleate complex of step (r) to yield a powdery solid iron oleate complex.

As one additional step the solid iron oleate complex as obtained in step (j) of the method of the present invention is isolated from the reaction mixture. This isolation is preferably carried out by a filtration process. The filtration may be performed according to any suitable method, e.g. by employing dynamic filtration like microfiltration, ultrafiltration, nanofiltration, reverse osmosis, or by using static filtration such as vacuum filtration, pressure filtration or membrane filtration etc. Furthermore, molecular sieves may be employed.

As further additional step the iron solid oleate complex of step (j) or (k) is washed with a polar solvent, e.g. a polar solvent as defined herein above. Preferably, washing is performed with acetone. The washing may include an agitation step as defined herein above. The amount of solvent for the washing procedure may be adjusted to the amount of product of step (j) or (k). For example, an amount of solvent of once, twice, 3 times, 4 times, 5 times, 6 times, 7 times, 8 times, 9 times, 10 times, 15 times, 20 times, 30 times, 50 times, or 100 times the volume or weight of the product of step (i) may be used.

As further, additional step the solid iron complex of one of the previous steps, in particular of step (l) is dissolved in a non-polar solvent, e.g. in a non-polar solvent as defined herein above, preferably in an alkane solvent, more preferably in hexane. The dissolving may be carried out as mentioned herein above, e.g. in the context of step (a).

In another, additional step, the solid iron oleate complex of step (m) is filtered. The filtration may be performed according to any suitable method, e.g. by employing dynamic filtration like microfiltration, ultrafiltration, nanofiltration, reverse osmosis, or by using static filtration such as vacuum filtration, pressure filtration or membrane filtration etc. Furthermore, molecular sieves may be employed.

In another, additional step, an excess of a polar solvent, preferably acetone, is added to the solid iron oleate complex of step (n). The term “excess of a polar solvent” as used herein refers to the weight or volume of the polar solvent, preferably of acetone, which surpasses the weight or volume of the iron oleate complex of step (n). The excess of the polar solvent may be in a ratio of 2:1, 3:1, 4:1, 5:1, 6:1, 7:1, 8:1, 9:1, 10:1, 11:1, 15:1, 20:1, 25:1, 30:1, 50:1, 100:1 etc., or any other suitable ratio. In a particularly preferred embodiment of the present invention an excess of acetone is used, more preferably an excess of acetone in a ratio of at least 4:1 is used.

As further, additional step the suspension of step (o) is mixed, preferably stirred for about 1 to 10 h. For example, the mixing may be carried out for 1 h, 1.5 h, 2 h, 2.5 h, 3 h, 3.5 h, 4 h, 4.5 h, 5 h, 5.5 h, 6 h, 6.5 h, 7 h, 7.5 h, 8 h, 8.5 h, 9 h, 9.5 h or 10 h. The mixing step may further be carried out for any period of time between these values. The suitable period of time may further be determined according to the condition of the iron oleate and/or the condition of the reaction mixture, e.g. the proportion of solid iron oleate in comparison to the overall volume of the reaction mixture, or the color and/or viscosity of the reaction mixture or the physical state of the iron oleate or the iron oleate phase. The term “physical state” as used herein refers to the appearance of the iron oleate or the iron oleate phase, which can be an oil, a viscous oil, a waxy solid, a solid, a free floating solid, a crystalline solid, or anything alike or in between.

As further, additional step the suspension of step (p) is filtered. The filtration may be performed according to any suitable method, e.g. by employing dynamic filtration like microfiltration, ultrafiltration, nanofiltration, reverse osmosis, or by using static filtration such as vacuum filtration, pressure filtration or membrane filtration etc. Furthermore, molecular sieves may be employed. This step may preferably be used in order to isolate solid iron oleate from the reaction mixture, i.e. in order to extract the soluble components from the solid components.

In another, additional step the iron oleate complex of step (q), which is typically in a solid form, is washed with a polar solvent. Preferably, washing is performed with acetone. The washing may include an agitation step as defined herein above. The amount of solvent for the washing procedure may be adjusted to the amount of product of step (q) For example, an amount of solvent of once, twice, 3 times, 4 times, 5 times, 6 times, 7 times, 8 times, 9 times, 10 times, 15 times, 20 times, 30 times, 50 times, or 100 times the volume or weight of the product of step (q) may be used. This washing step may be carried out once or preferably be repeated together with the filtration step (q) as mentioned above one time, two times, 3 times, 4 times, 5 times, 6 times or more often. In a particularly preferred embodiment, said washing/filtration step repetition is carried out until a solid iron oleate complex is obtained, more preferably until a powdery iron oleate complex is obtained.

In yet another, additional step the iron oleate complex of step (r) is dried. For the drying process any suitable procedure known to the person skilled in the art may be used, e.g. an exsiccator, typically based on the use of silica or P₄O₁₀, or an oven etc. The drying procedure may preferably be carried out until a solid iron oleate complex is obtained. More preferably, a powdery solid iron oleate complex may be obtained.

In another aspect the present invention relates to an iron oleate, an iron oleate complex or an iron oleate compound which is obtainable or obtained by any method or method variant as defined herein above. The iron oleate, iron oleate complex or iron oleate compound may be in any suitable form, state or condition, e.g. it may be provided as solid iron oleate, as powdery solid iron oleate, or dissolved in any suitable solvent or buffer, preferably in hexane. Most preferably, the iron oleate is obtained as a solid material.

In another aspect the present invention relates to an iron complex of formula I, wherein R¹ and/or R² is an alkyl moiety comprising at least 5 carbon atoms and wherein L¹, L², L³ and L⁴ are auxiliary ligands.

In a preferred embodiment the iron complex is iron oleate wherein R¹ and R² is (CH₂)₇(CH)=(CH)(CH₂)₇CH₃. Alternatively, R¹ and/or R² may also be an (C₅-C₁₀) alkyl. The term “(C₅-C₁₀) alkyl” means a straight chain or branched non-cyclic hydrocarbon having from 5 to 10 carbon atoms. Representative straight chain —(C₅-C₁₀)alkyls include -n-pentyl, -n-hexyl, -n-heptyl, -n-octyl, -n-nonyl, and -n-decyl. Representative branched —(C₅-C₁₀)alkyls include -iso-pentyl, -neo-pentyl, 1-methylbutyl, 2-methylbutyl, 3-methylbutyl, 1,1-dimethylpropyl, 1,2-dimethylpropyl, 1-methylpentyl, 2-methylpentyl, 3-methylpentyl, 4-methylpentyl, 1-ethylbutyl, 2-ethylbutyl, 3-ethylbutyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-methylhexyl, 2-methylhexyl, 3-methylhexyl, 4-methylhexyl, 5-methylhexyl, 1,2-dimethylpentyl, 1,3-dimethylpentyl, 1,2-dimethylhexyl, 1,3-dimethylhexyl, 3,3-dimethylhexyl, 1,2-dimethylheptyl, 1,3-dimethylheptyl, and 3,3-dimethylheptyl.

In a further embodiment R¹ and/or R² may also be an alkyl with more than 10 carbon atoms, e.g. C₁₁, C₁₂, C₁₃, C₁₄, C₁₅, C₁₆, C₁₇, C₁₈, C₂₀, C₂₁, C₂₂, C₂₃, C₂₄, C₂₅ etc.

The term “auxiliary ligand” as used herein refers to a ligand able to bind to or interact with an iron complex as depicted in formula I. Preferred examples of such ligands are neutral molecules, anionic molecules or solvent molecules. L¹ to L⁴ may be identical or different, e.g. independent of each other. Furthermore, L¹ and L² may be identical, whereas L³ and L⁴ are different from L¹ and L² and/or different form each other. Alternatively, L³ and L⁴ may be identical, whereas L¹ and L² are different from L³ and L⁴ and/or different form each other. Alternatively, L¹ and L³ may be identical, whereas L² and L⁴ are different from L¹ and L³ and/or different form each other. Alternatively, L¹ and L⁴ may be identical, whereas L² and L³ are different from L¹ and L⁴ and/or different form each other. In a further embodiment L¹ to L⁴ may be from the same functional group, e.g. neutral molecules, anionic molecules or solvent molecules, or L¹ to L⁴ may be each derived from different functional groups, e.g. L¹ and L² a neutral molecule, L³ an anionic molecule and L⁴ a solvent molecule etc. Furthermore, the functional groupings may be present according to the above mentioned system, i.e. L¹ and L² may from an identical functional grouping, whereas L³ and L⁴ are different from L¹ and L² and/or different form each other etc.

The ligands may be coordinated in a mono-, di-, or tridentate fashion to the iron ion. In a particular embodiment not all ligands need to be present, hence the coordination site of at least one, two, or three of the ligands may be void, e.g. the coordination site of L¹, L², L³ or L⁴ may be void, or the coordination site of L¹ and L², L³ and L⁴, L¹ and L³, L¹ and L⁴ etc. may be void.

In a preferred embodiment of the present invention L¹ and/or L² and/or L³ and/or L⁴ may be acetone, methanol, ethanol, water, tetrahydrofurane, imidazole, methylimidazole, pyridine, formamide, dimethylformamide, pyrolidon, 1-methyl-2-pyrolidon, hydroxide, fluoride, chloride, bromide, iodide, sulfate, bisulfate, phosphate, biphosphate, nitrate, sulfide, bisulfide, oxalate, lactate, cyanide, cyanate, isocyanate, thiocyanate, isothiocyanate, acetylacetonate, carbonate, bicarbonate, azide, benzoate, acrylate, methacrylate, sulfite, bisulfite, methoxide, ethoxide, cyclohexanesulfonate, methanesulfonate, ethanesulfonate, propanesulfonate, pentanesulfonate, hexanesulfonate, octanesulfonate, decanesulfonate, dodecanesulfonate, octadecanesulfonate, citrate, tartrate, borate, hydrogen borate, dihydrogen borate, nitrite, perborate, peroxide, thiosulfate, methionate, acetate, propionate, butyrate, pentanoate, hexanoate, heptanoate, octanoate, decanoate, dodecanoate, pentadecanoate, hexadecanoate, octadecanoate, or oleate.

In a particularly preferred embodiment L¹ and/or L² and/or L³ and/or L⁴ is hydroxide. In a further particularly preferred embodiment L¹ and/or L² and/or L³ and/or L⁴ is acetone. If only one, two or three of L¹ to L⁴ is/are hydroxide or acetone, the other auxiliary ligand may preferably be methanol, ethanol, water, tetrahydrofurane, imidazole, methylimidazole, pyridine, formamide, dimethylformamide, pyrolidon, 1-methyl-2-pyrolidon, fluoride, chloride, bromide, iodide, sulfate, bisulfate, phosphate, biphosphate, nitrate, sulfide, bisulfide, oxalate, lactate, cyanide, cyanate, isocyanate, thiocyanate, isothiocyanate, acetylacetonate, carbonate, bicarbonate, azide, benzoate, acrylate, methacrylate, sulfite, bisulfite, methoxide, ethoxide, cyclohexanesulfonate, methanesulfonate, ethanesulfonate, propanesulfonate, pentanesulfonate, hexanesulfonate, octanesulfonate, decanesulfonate, dodecanesulfonate, octadecanesulfonate, citrate, tartrate, borate, hydrogen borate, dihydrogen borate, nitrite, perborate, peroxide, thiosulfate, methionate, acetate, propionate, butyrate, pentanoate, hexanoate, heptanoate, octanoate, decanoate, dodecanoate, pentadecanoate, hexadecanoate, octadecanoate, or oleate. Also any subgrouping of theses ligand may be present.

In a further embodiment the iron complex, in particular the iron oleate complex as defined herein above may be balanced with suitable counter ions. Preferred examples of such suitable counter ions are hydronium, lithium, sodium, potassium, ammonium, tetramethylammonium, tetraethylammonium, tetrabutylammonium, Further suitable counter ions are known to the person skilled in the art and are also envisaged by the present invention.

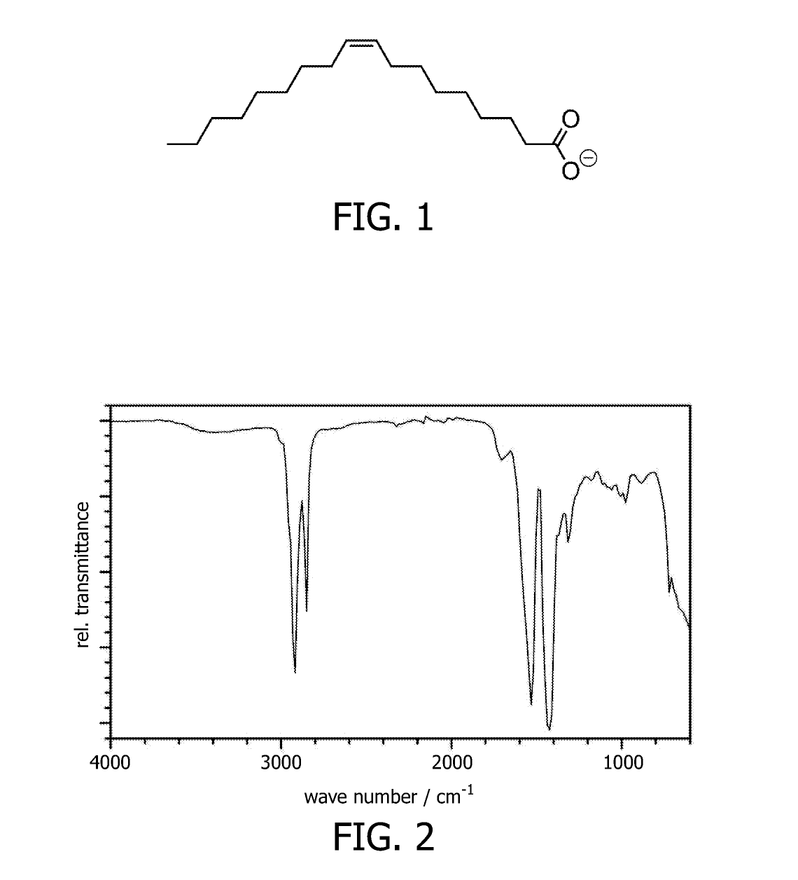

In a further preferred embodiment said iron oleate complex of the present invention has the molecular formula Fe₂O(oa)₂(OH)₂(OC(CH₃)₂)₂. The term “oa” stands for the oleate anion. Preferably said oleate anion has a structure as depicted in FIG. 1.

In another aspect the present invention relates to the use of the iron oleate complex as defined herein above, or the iron oleate complex obtainable or obtained by a method of the present invention, as described herein, as precursor for the preparation of nanoparticles. The term “precursor” as used herein refers to the quality of the iron oleate complexes, iron oleate compounds or solutions thereof as starting material for the synthesis of nanoparticles. Typically, such starting material is combined with additional ingredients. In further embodiments the iron oleate complex as defined herein above, or the iron oleate complex obtainable or obtained by a method of the present invention, as described herein, may also be used for different purposes, e.g. the production of higher molecular iron clusters, the production of iron microparticles, the production of mixed metal particles, e.g. comprising iron and, for example, aluminium, cobalt, nickel, copper, chromium, vanadium, titanium, ruthenium etc. Furthermore, the iron oleate complex as defined herein above, or the iron oleate complex obtainable or obtained by a method of the present invention, as described herein may be used for the separation and precipitation of iron oxide layers from a reaction mixture, preferably of thin iron oxide layers.

In a particularly preferred embodiment, the iron oleate complex as defined herein above, or the iron oleate complex obtainable or obtained by a method of the present invention, as described herein may also be used for the synthesis of iron oxide nanoparticles. In a further aspect the present invention accordingly refers to a method of forming iron oxide nanoparticles comprising the steps of:

(a) suspending oleic acid and the iron oleate complex as defined herein above, or the iron oleate complex obtainable or obtained by a method of the present invention, as described herein, and optionally oleylamine, in a primary organic solvent;

(b) increasing the temperature of the suspension by a defined rate up to a maximum of 340° C. to 500° C.;

(c) aging the suspension at the maximum temperature of step (b) for about 0.5 to 6 h;

(d) cooling the suspension;

(e) adding a secondary organic solvent;

(f) precipitating nanoparticles by adding a non-solvent and removing excess solvent;

(g) dispersing said nanoparticles in said secondary organic solvent;

(h) mixing the dispersion of step (g) with a solution of a polymer; and

(i) optionally removing said secondary organic solvent.

The initial step of the synthesis comprises suspending of an iron oleate, iron olate complex, iron oleate compound or a solution thereof in a suitable solvent together with oleic acid in a primary organic solvent. The term “primary organic solvent” as used herein refers to an organic solvent which is suitable for higher temperature boiling reactions. Preferably the primary organic solvent is an alkane. More preferably said alkane is a saturated alkane, even more preferably a linear saturated alkane. The solvent may be used alone or in a mixture with a different solvent, e.g. a mixture of two alkanes may be used as solvents. Preferred is the use of pure solvents, e.g. alkane solvents, since they allow for a better temperature control.

In a preferred embodiment of the present invention the primary organic solvent may be represented by the general formula CₙH₂ₙ₊ₘ, with 15≦n≦30, and −2≦m≦2, preferably with 18≦n≦22, and 0≦m≦2, more preferably with n=20 and m=2. Examples of these solvents to be used are octadecene, tricosane, and paraffin wax. Particularly preferred is icosane as primary organic solvent. Alternatively higher alkane solvents with the indicated boiling points (in parentheses) may be used, preferably at higher temperatures, more preferably at temperatures at about the indicated boiling points: henicosane (357° C.), docosane (366° C.), tricosane (380° C.), tetracosane (391° C.), pentacosane (402° C.), hexacosane (412° C.), heptacosane (422° C.), octacosane (432° C.), nonacosane (441° C.), triacosane (450° C.), hentriacontane (458° C.), dotriacontane (467° C.), tritriacontane (475° C.), tetratriacontane (483° C.), pentatriacontane (490° C.), hexatriacontane (497° C.). Furthermore, any combination or sub-grouping of two or more of these solvents may be used.

In a specific embodiment of the present invention the primary organic solvent to be used may be chosen according to the temperature of nanoparticle synthesis step (b). For example the boiling point of icosane is about 343° C.; icosane may therefore preferably be used for reactions at a temperature of about 340° C.

Alternatively, the pressure conditions of the reaction may be adjusted, e.g. the pressure may be increased, allowing the employment of primary organic solvents as mentioned herein at temperatures above the indicated boiling points.

The oleic acid to be used may be an oleic acid, e.g. as depicted in FIG. 1, or a derivative thereof. Examples of preferred oleic acid derivatives are ammonium oleate, tetramethylammonium oleate, tetraethylammonium oleate, tetrapropylammonium oleate, tetrabutylammonium oleate, benzylammonium oleate, potassium oleate, magnesium oleate, lithium oleate, sodium oleate, potassium oleate, aluminium oleate or calcium oleat. Preferred oleic acid derivatives are alkyl-ammonium oleates, in which the ammonium group can be generally described as R¹R²R³R⁴N⁺, with R¹, R², R³, R⁴ being identical or independently different alkyl, aryl, or silyl groups or a hydrogen. Particularly preferred is the employment of oleic acid.

In a further embodiment a combination of oleylamine and the iron oleate complex as defined herein above, or the iron oleate complex obtainable or obtained by a method of the present invention, as described herein is suspended in a primary organic solvent as defined herein. Alternatively, a combination of oleylamine and the iron oleate complex as defined herein above, or the iron oleate complex obtainable or obtained by a method of the present invention, as described herein together with oleic acid or an oleic acid derivative may be suspended in a primary organic solvent as defined herein.

The amount of solvent for the suspension step may be adjusted to the amount of ingredients to be suspended. For example, an amount of solvent of once, twice, 3 times, 4 times, 5 times, 6 times, 7 times, 8 times, 9 times, 10 times, 15 times, 20 times, 30 times, 50 times, or 100 times the volume or weight of the ingredients to be dissolved may be used.

The suspension step may be carried out according to any suitable technique, e.g. by stirring the ingredients in the solvent, shaking of the reaction mixture, rotating movements etc. The suspension step may be performed until the oleic acid and/or the oleylamine and the iron oleate complex are entirely suspended, e.g. until no iron oleate precipitate is optically detectable. The suspension step may be carried out, for example, for about 1 min, 2 min, 5 min, 10 min, 20 min, 30 min, 45 min or 60 min, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h or 24 h or any period of time in between these values.

The suspension step may be carried out at any suitable temperature, preferably at about 35° C. to 65° C., e.g. at about 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C. or 65° C. The temperature may further be lowered to about 25° C. or increased to about 75° C. During the suspension step the temperature may be kept constant, e.g. at any of the above indicated levels, or may be varied. For instance, the temperature may first be set to a lower level, e.g. about 35° C., and subsequently be increased, e.g. up to about 50° C., 55° C., 60° C. or 65° C. Alternatively, the temperature may first be set to a higher level, e.g. to about 50° C., 55° C., 60° C., or 65° C., and subsequently be decreased, e.g. down to 35° C., 40° C. or 45° C. Furthermore, temperature profiles of combined increases and decreases in various sequences may be used, e.g. first a decrease, followed by an increase and finally a decrease etc.

In a particular embodiment of the present invention the iron oleate complex as mentioned above, oleic acid or a derivative thereof and the primary organic solvent may be used in specific molar or mass ratio. For example, a mass ratio of about 1-3:2-5:3-6 may be employed. In a particularly preferred embodiment a mass ratio of 1:4.4:6 of iron oleate:oleic acid:icosane may be employed.

In a further step of the synthesis of nanoparticles the temperature of the suspension may be increased to a maximum of 340° C. to 500° C. Preferably, the temperature of the suspension may be increased to a maximum of 340° C. to 400° C. The maximum temperature may, for example, be 340° C., 341° C., 342° C., 343° C., 344° C., 345° C., 350° C., 360° C., 370° C., 380° C., 390° C., 400° C., 410° C., 420° C., 430° C., 440° C., 450° C., 460° C., 470° C., 480° C., 490° C. or 500° C. Also higher temperatures above 500° C. are envisaged by the present invention.

In a particularly preferred embodiment, said maximum temperature may be chosen in accordance with the boiling point of the used primary organic solvent, e.g. for icosane about 340-343° C., for henicosane about 357° C., for docosane about 366° C., for tricosane about 380° C., for tetracosane about 391° C., for pentacosane about 402° C., for hexacosane about 412° C., for heptacosane about 422° C., for octacosane about 432° C., for nonacosane about 441° C., for triacosane about 450° C., for hentriacontane about 458° C., for dotriacontane about 467° C., for tritriacontane about 475° C., for tetratriacontane about 483° C., for pentatriacontane about 490° C., or for hexatriacontane about 497° C.

The temperature increase may preferably be accomplished by augmenting the temperature at a defined rate, preferably at a rate of 1° C. to 10° C. per minute, per 2 minutes, per 3 minutes or per 5 minutes. For instance, the temperature may be augmented at a rate of 1° C., 2° C., 2.5° C., 3° C., 3.5° C., 4° C., 4.5° C., 5° C., 6° C., 7° C., 8° C., 9° C. or 10° C. per minute, per 2 minutes, per 3 minutes or per 5 minutes. Preferably, the temperature may be increased by a rate of 3.3° C. per minute.

In a further step of the synthesis of nanoparticles the suspension of step (b) is aged or boiled at the maximum temperature of step (b) for about 0.5 to 6 h. The aging or boiling may, for example, be carried out for 0.5 h, 0.75 h, 1 h, 1.5 h, 2 h, 2.5 h, 3 h, 3.5 h, 4 h, 4.5 h, 5 h, 5.5 h or 6 h. Furthermore, longer aging/boiling periods of >6 h are also envisaged by the present invention. During the aging/boiling step of the synthesis the temperature may preferably be kept at the maximum temperature of the previous step, e.g. at 340° C. Alternatively, the temperature may be varied within the range of maximum temperatures of 340° C. to 500° C. In a further embodiment, the temperature may also be lowered to values of about 200° C., 250° C., 300° C., 310° C., 320° or 330° C. Such temperature modifications may be performed once or more than one time, reverting after each modification to the maximum temperature as used in step (b). The modifications of the temperature, i.e. the periods of increased or decreased temperatures in comparison to the maximum temperature of step (b), may be short, e.g. in the range of 10 to 20 min, or prolonged, e.g. more than 30 min, more than 1 h, 2 h, 3 h, 4 h. The period may depend on the period of the aging step.

In a further step of the synthesis of nanoparticles the suspension of step (c) is cooled. The cooling may be carried out by using suitable cooling equipment, or by a transfer to a suitably cooled environment. Preferably, the suspension is cooled to a temperature of about 40° C. to 90° C., more preferably to a temperature of about 50° C. to 80° C. The reaction mixture may, for example, be cooled to a temperature of about 40° C., 45° C., 50° C., 55° C., 60° C., 65° C., 70° C., 75° C., 80° C., 85° C., or 90° C.

The cooling may be performed by an immediate temperature change, e.g. to any of the above indicated temperatures. Alternatively, the cooling may be carried out gradually, e.g. by decreasing the temperature of the reaction mixture of step (d) by 1, 2, 3, 4, 5, 6, 7, 8, 9, 10, 15 or 20° C. per minute, per 2 minutes, per 5 minutes, per 10 minutes or per 20 minutes.

In a further step of the synthesis of nanoparticles to the suspension of step (d) a secondary organic solvent is added. The term “secondary organic solvent” as used herein refers to an organic solvent which is suitable for lower temperature reactions, e.g. reactions in a temperature range of 40° C. to 90° C. Preferably said secondary organic solvent has a lower boiling point than the primary organic solvent, e.g. at a range of 30° C. to 90° C., and/or a lower viscosity. Secondary organic solvents may preferably be short-chain alkanes. Preferred examples of secondary organic solvents to be used in the context of this synthesis step are pentane, isopentane, neopentane, hexane, heptane, dichloromethane, chloroform, tetrachloromethane and dichloroethane. Particularly preferred is the use of pentane or hexane. The secondary organic solvent may be used alone or in a mixture with a different solvent, e.g. a mixture of two short chain alkanes may be used as solvents. Preferred is the use of pure solvents.

In a further step of the synthesis of nanoparticles a non-solvent is added to the reaction mixture of step (e), leading to the precipitation of nanoparticles. The term “non-solvent” as used herein means an organic compound with a low boiling point. Preferred examples of non-solvents are acetone, 2-butanone, 2-pentanone, isobutyl methyl ketone, tetrahydrofurane, diethylether and diisopropylether. The addition of the non-solvent may be carried out, in a specific embodiment, by agitating the reaction mixture, e.g. by a method of agitation as defined herein above. The amount or volume of non-solvent for the addition may be adjusted to the amount or volume of product of step (f).

The precipitation may be enhanced by centrifugation, e.g. for a period of 10 min to 60 min. The centrifugation may be performed at any suitable velocity, e.g. a 3,000 to 10,000 rpm, preferably at about 4,900 rpm.

Subsequently, excess solvent or supernatant may be discarded. Precipitated nanoparticles may be obtained and kept for the next synthesis step.

In a further step of the synthesis of nanoparticles the nanoparticles obtained in step (f) are dissolved in a secondary organic solvent as defined herein above. As secondary organic solvent either the same solvent used for step (e) may be used, or a different solvent may be employed. Preferably, pentane or hexane may be used. The amount of solvent for the dispersion step may be adjusted to the amount of precipitated product of step (f). For example, an amount of secondary organic solvent of once, twice, 3 times, 4 times, 5 times, 6 times, 7 times, 8 times, 9 times, 10 times, 15 times, 20 times, 30 times, 50 times, or 100 times the volume or weight of the product of step (f) may be used. The mixing may be performed for any suitable period of time, e.g. for about 30 min to 24 h, preferably for about 45 min to 18 h, more preferably for about 1 h to 14 h.

The precipitation and subsequent dispersion of nanoparticles may be carried out only one time or be repeated once, twice, 3 times, 4 times, 5 times, 6 times or more often. A repetition of these steps is supposed to help increasing the purity of the nanoparticles.

In a particular embodiment of the present invention, nanoparticles synthesized in accordance with the above described steps may be dispersed in a defined volume of secondary organic solvent, preferably in hexane, e.g. in a volume of 10 ml of hexane. Accordingly dispersed nanoparticles may subsequently be used for analytical approaches, e.g. experiments and analyses as described in the Examples, or for alternative synthesis or modification steps.

Accordingly obtained nanoparticles may be present in a monodisperse form, or be present in a polydisperse form. The term “monodisperse” as used herein refers to a narrow nanoparticle size distribution. Monodisperse nanoparticles according to the present invention may have a size which differs only by 0.1 to 3 nm from the average size of a larger group of nanoparticles, e.g. a group of 1,000, 10,000 or 50,000 nanoparticles obtained according to the presently described method. “Polydisperse” forms may have a size which differs by more than 3 nm from the average size of a larger group of nanoparticles, e.g. a group of 1,000, 10,000 or 50,000 nanoparticles obtained according to the presently described method. Such nanoparticles may be present in distinct size groups, each being monodisperse, or may present in statistical or broader size distribution.

Monodisperse nanoparticles may either be employed directly for additional synthesis steps or be combined with different size groups. Polydisperse nanoparticles may either be used directly or alternatively be subjected to a size fractionation or separation procedure in order to obtain monodisperse nanoparticles, or in order to reduce the polydisperse character of the nanoparticle group. For example, a size fractionation or separation may be carried out according to approaches or based on the use of apparatuses or systems as described in WO 2008/099346 or WO 2009/057022. Alternatively or additionally a fractionation or separation according to the particle form may be carried out

In yet another step of the synthesis of nanoparticles the dispersion of step (g) or any derived, fractioned, separated or otherwise modified mixture of nanoparticles according to the present invention is mixed with a solution of a polymer. Preferred solutions polymers are essentially aqueous buffer solutions of a hydrophilic biocompatible copolymer comprising poly ethylene glycol (PEG) and/or poly propylene glycol (PPG). Further preferred are essentially aqueous solutions of an amphiphilic phospholipid comprising PEG. Additionally preferred are essentially aqueous buffer solutions of an amphiphilic block-copolymer.

The term “essentially aqueous” as used herein refers to the presence of at least 51% to 99.999% of H₂O molecules in the solution or buffer.

Particularly preferred is the employment of a poly(ethylene glycol)-block-polypropylene glycol)-block-poly(ethylene gycol) (PEG-PPG-PEG), e.g. Pluronic. Even more preferred is the use of Pluronic F68, Pluronic F108 or Pluronic F127. Most preferred is the use of PluronicF127.

Further, suitable polymers to be used in this synthesis step are amphiphilic PEGylated phospholipids or lipids. A preferred example of these phospholipids is DSPE-PEGx-Y, in which Y═OH, OCH₃, OCH₂CH₃, x=200-5000, or DSPE=1,2-distearoyl-sn-glycero-3-phosphoethanolamine. A preferred example of a lipid is 1,2-distearoyl-sn-glycero-3-phosphoethanolamine-N-[methoxy(polyethylene glycol)-2000] (ammonium salt) (DSPE-PEG2000(OMe)).

The amount of polymer solution for the mixing step may be adjusted to the amount of precipitated product of step (f) or the volume of step (g). For example, an amount of polymer solution of once, twice, 3 times, 4 times, 5 times, 6 times, 7 times, 8 times, 9 times, 10 times, 15 times, 20 times, 30 times the volume of the reaction mixture of step (g) may be used. The mixing may be performed for any suitable period of time, e.g. for about 5 min to 24 h, preferably for about 45 min to 18 h, more preferably for about 1 h to 14 h.

In a preferred embodiment the mixing step may be carried out by stirring the two-phase mixture, e.g. in an essentially non-closed system.

In a further embodiment of the present invention the dispersion of step (g) is mixed with a hydrophilic or amphiphilic stabilizer. Preferred examples of such a stabilizer are citric acid, tartaric acid, lactic acid, oxalic acid, and/or any salt thereof, a dextran, carboxydextran, a polyethylenoxide-based polymer or co-polymer, or any combination thereof. The amount of stabilizer for the mixing step may be adjusted to the amount of precipitated product of step (f) or the volume of step (g). For example, an amount of stabilizer of once, twice, 3 times, 4 times, 5 times, 6 times, 7 times, 8 times, 9 times, 10 times, 15 times, 20 times, 30 times the volume of the reaction mixture of step (g) may be used. The mixing may be performed for any suitable period of time, e.g. for about 5 min to 5 days, preferably for about 45 min to 48 h, more preferably for about 1 h to 24 h.

In a preferred embodiment the mixing step may be carried out by stirring the two-phase mixture, e.g. in an essentially non-closed system.

In a final, optional step of the synthesis of nanoparticles in the solution of nanoparticles obtained in the previous step, either by mixing with a polymer solution, or by mixing with a hydrophilic or amphiphilic stabilizer, said secondary organic solvent may be removed. This removal may be performed by letting the secondary organic solvent evaporate, preferably during the mixing procedure of step (h). Accordingly, the evaporation step may be performed by increasing the surface of the reaction mixture, e.g. by employing suitable reaction vessels or by agitating the reaction mixture. Additionally or alternatively, the gaseous space or areal in contact with the liquid reaction mixture may be altered by ventilation or gas exchange step in order to reduce the concentration of volatiles in said space or areal.

The synthesis results thus in an aqueous solution of hydrophilic nanoparticles.

Accordingly obtained nanoparticles may be present in a monodisperse form, or be present in a polydisperse form as defined herein above, e.g. in dependence on the performance of any separation or fraction step carried out during the synthesis procedure as mentioned above. Accordingly, monodisperse nanoparticles may either be employed directly or be combined with different size groups. Polydisperse nanoparticles may also either be used directly or alternatively be subjected to a size fractionation or separation procedure in order to obtain monodisperse nanoparticles, or in order to reduce the polydisperse character of the nanoparticle group, as described herein above.

In a further embodiment of the present invention said nanoparticles or solution of nanoparticles as obtained according to the above defined steps or variants thereof may further be treated, modified or varied according to the additional method steps of:

(j) purifying the nanoparticle or nanoparticle solution obtainable in the step (i);

(k) treating the nanoparticle or nanoparticle solution obtainable in step (i) or (j) with an oxidizing or reducing agent;

(l) modifying the surface of the nanoparticle obtainable in step (i), (j) or (k) by removing, replacing or altering the coating;

(m) encapsulating or clustering the nanoparticle obtainable in step (i) to (l) with a carrier such as a micelle, a liposome, a polymersome, a blood cell, a polymer capsule, a dendrimer, a polymer, or a hydrogel; and

(n) decorating the nanoparticle obtainable in step (i) to (m) with a targeting ligand.

The purification of the nanoparticle or nanoparticle solution obtainable in the step (i) or any variant thereof may be carried out by, e.g. filtrating the solution. Suitable filtration methods have been described herein above.

In another, optional step the nanoparticle or nanoparticle solution obtainable in step (i) or (j) or any variant thereof may be treated with an oxidizing or reducing agent. Examples of these agents are trimethylamine-N-oxide, pyridine-N-oxide, ferrocenium hexafluorophosphate and ferrocenium tetrafluorborate. Preferred is the employment of trimethylamine-N-oxide.

Furthermore, the surface of the nanoparticle obtainable in step (i), (j) or (k) or any variant thereof may be modified by removing, replacing or altering the coating. Such modifications may be carried out according to suitable chemical reactions known the person skilled in the art, e.g. reactions as mentioned in F. Herranz et al., Chemistry—A European Journal, 2008, 14, 9126-9130; F. Herranz et al. Contrast Media & Molecular Imaging, 2008, 3, 215-222; J. Liu et al. Journal of the American Chemical Society, 2009, 131, 1354-1355; W. J. M. Mulder et al., NMR in Biomedicine, 2006, 19, 142-164; or E. V. Shtykova et al, Journal of Physical Chemistry C, 2008, 112, 16809-16817.

In another, optional, additional or alternative step the nanoparticle obtainable in step (i) to (l) or any variant thereof may be encapsulated in or clustered with a carrier. Preferably, a carrier structure comprising or composed of one or more suitable amphipathic molecules a such as lipids, phospho lipids, hydrocarbon-based surfactants, choloesterol, glycolipids, bile acids, saponins, fatty acids, synthetic amphipathic block copolymers or natural products like egg yolk phospholipids etc. may be used. Particularly preferred are phospholipids and synthetic block copolymers. Particularly preferred examples of suitable carriers are a micelle, a liposome, a polymersome, a blood cell, a polymer capsule, a dendrimer, a polymer, or a hydrogel or any mixtures thereof.

The term “micelle” as used herein refers to a vesicle type which is also typically made of lipids, in particular phosopholipids, which are organized in a monolayer structure. Micelles typically comprise a hydrophobic interior or cavity.

The term “liposome” as used herein refers to a vesicle type which is typically made of lipids, in particular phospholipids, i.e. molecules forming a membrane like structure with a bilayer in aqueous environment. Preferred phospho lipids to be used in the context of liposomes include phosphatidylethanolamine, phosphatidylcho line, egg phosphatidylethanolamine, dioleoylphosphatidylethanolamine. Particularly preferred are the phospholipids MPPC, DPPC, DPPE-PEG2000 or Liss Rhod PE.

The term “polymersome” as used herein means a vesicle-type which is typically composed of block copolymer amphiphiles, i.e. synthetic amphiphiles that have an amphiphilicity similar to that of lipids. By virtue of their amphiphilic nature (having a more hydrophilic head and a more hydrophobic tail), the block copolymers are capable of self-assembly into a head-to-tail and tail-to-head bilayer structure similar to liposomes. Compared to liposomes, polymersomes have much larger molecular weights, with number average molecular weights typically ranging from 1000 to 100,000, preferably of from 2500 to 50,000 and more preferably from 5000 to 25000, are typically chemically more stable, less leaky, less prone to interfere with biological membranes, and less dynamic due to a lower critical aggregation concentration. These properties result in less opsonisation and longer circulation times.

The term “dendrimer” as used herein means a large, synthetically produced polymer in which the atoms are arranged in an array of branches and sub-branches radiating out from a central core. The synthesis and use of dendrimers is known to a person of skill in the art.

The term “hydrogel” as used herein means a colloidal gel in which water is the dispersion medium. Hydrogels exhibit no flow in the steady-state due to a three-dimensional crosslinked network within the gel. Hydrogels can be formed from natural or synthetic polymers. The obtainment and use of hydrogels is known to a person of skill in the art.

In another, optional, additional or alternative step the nanoparticle obtainable in step (i) to (m) or any variant thereof may be decorated with a targeting ligand.

The term “targeting ligand” as used herein refers to a targeting entity, which allows an interaction and/or recognition of the decorated nanoparticle by compatible elements, or stabilizing or destabilizing elements, which modify the chemical, physical and/or biological properties of the nanoparticle. These elements are typically present at the outside or outer surface of the nanoparticle. Particularly preferred are elements which allow a targeting of the nanoparticle to specific tissue types, specific organs, cells or cell types or specific parts of the body, in particular the animal or human body. For example, the presence of target ligands may lead to a targeting of the nanoparticle to organs like liver, kidney, lungs, heart, pancreas, gall, spleen, lymphatic structures, skin, brain, muscles etc. Alternatively, the presence of targe ligands may lead to a targeting to specific cell types, e.g. cancerous cells which express an interacting or recognizable protein at the surface. In a preferred embodiment of the present invention the nanoparticle may comprise proteins or peptides or fragments thereof, which offer an interaction surface at the outside of the nanoparticle. Examples of such protein or peptide elements are ligands which are capable of binding to receptor molecules, receptor molecules, which are capable of interacting with ligands or other receptors, antibodies or antibody fragments or derivatives thereof, which are capable of interacting with their antigens, or avidin, streptavidin, neutravidin, lectins. Also envisaged by the present invention is the presence of binding interactors like biotin, which may, for example be present in the form of biotinylated compounds like proteins or peptides etc. The nanoparticle may also comprise vitamins or antigens capable of interacting with compatible integrators, e.g. vitamin binding protein or antibodies etc.

In another aspect the present invention relates to an iron oxide nanoparticle which is obtainable or obtained by any nanoparticle synthesis method or method variant as defined herein above. The iron oxide nanoparticle may be in any suitable form, state or condition, e.g. it may be provided as solid iron oxide nanoparticle, as dissolved iron oxide nanoparticle, e.g. dissolved in any suitable solvent or buffer. Furthermore, the iron oxide nanoparticle may be provided in a monodisperse form or in a polydisperse form as defined herein above.

In yet another aspect the present invention relates to the use an iron oxide nanoparticle as defined herein above or an iron oxide nanoparticle obtainable or obtained by any method or method variant as defined herein above, as a tracer for Magnetic Particle Imaging (MPI) or Magnetic Particle Spectroscopy (MPS), or for a combination of MPI and MPS, e.g. as contrast agent. In a further, particular embodiment of the present invention said iron oxide nanoparticle may also be used for classical magnetic resonance imaging (MRI), e.g. as contrast agent.

Accordingly, an iron oxide nanoparticle obtainable or obtained by any method or method variant as defined herein above may be employed in methods of diagnosis or treatment of a disease or pathological condition, or as ingredient of a diagnostic or pharmaceutical composition, e.g. for the treatment or diagnosis of a diseases or pathological conditions, in particular a disease, disorder, tissue or organ malfunction etc., which is targetable by a nanoparticle as defined herein above.

In a further embodiment of the present invention an iron oxide nanoparticle obtainable or obtained by any method or method variant as defined herein above may be used for transport purposes, e.g. in combination with a drug. For example, such a drug may be released at a specified position within the human or animal body.

The following examples and figures are provided for illustrative purposes. It is thus understood that the example and figures are not to be construed as limiting. The skilled person in the art will clearly be able to envisage further modifications of the principles laid out herein.

### EXAMPLES

### Example 1

### Synthesis of Iron Oleate (Sample 1)

Sodium oleate (20.27 g, 66.6 mmol) was dissolved in MeOH (180 ml) at 50° C. in a nitrogen atmosphere. Hexane (720 ml) was added to the clear and colorless methanol solution in small portions under vigorous stirring. FeCl₃.6H₂O (6.0 g, 22.2 mmol) was dissolved in MeOH (15 ml) and added slowly in a nitrogen atmosphere to the warm sodium oleate solution through a dropping funnel. The color of the reaction mixture changed to yellow and later to orange while a white precipitate of sodium chloride was formed. After the addition of the FeCl₃.6H₂O solution was completed, the reaction mixture was stirred at 50° C. for 1 hour. After the mixture had cooled to room temperature it was filtered and transferred into a reparatory funnel. The orange-red MeOH phase was separated from the yellow-green hexane phase. The product was then washed with MeOH (4×100 ml) until the MeOH phase remained colorless. The yellow-green hexane solution was dried over Mg₂SO₄, filtered and the solvent was evaporated, leaving a dark red viscous oil behind. This oil was stirred in acetone (500 ml) overnight, whereupon it hardened. The red-brown solid product was filtered from the orange solution and washed with acetone (50 ml). The solid was dissolved in hexane (60 ml), the obtained solution was filtered through a syringe filter (0.45 μm pore size) and transferred into a dripping funnel. The dark red solution was added dropwise to acetone (500 ml) under intensive stirring. A precipitate of small red brown chunks was formed that were disaggregated by stirring continuously overnight. The powdery product was filtered from the orange-red acetone solution and remaining bigger chunks of product were minced with a spatula. The combined red-brown powders were than washed with acetone (3×50 ml). The product was finally dried in vacuo using an oil pump and stored over silica.

Samples 2 and 3 were each prepared in independent experiments as outlined above.

TABLE 1
Elemental analysis data of 3 different batches of iron
oleate and calculated composition based on the formula
[Fe₂O(oa)₂(OH)₂(OC(CH₃)₂)₂]

| | % Fe | % C | % H |
|---|---|---|---|
| Sample 1 | 12.8 | 59.7 | 9.4 |
| Sample 2 | 13.2 | 60.8 | 9.7 |
| Sample 3 | 13.5 | 59.9 | 9.6 |
| Average | 13.2 | 60.1 | 9.6 |
| calculated | 13.3 | 60.0 | 9.6 |

As can be derived from FIG. 2 the Fourier-transform infrared spectrum of the obtained iron oleate showed the characteristic peaks of coordinated oleate anions, including the characteristic COO group vibrations between 1400 and 1600 cm⁻¹ as well as strong C—H stretch vibration between 2800 and 3000 cm⁻¹, an O—H vibration between 1600 and 1800 cm⁻¹. Below 800 cm⁻¹ the onset of Fe—O stretch vibrations was detectable.

### Example 2

### Thermal Decomposition of Sodium Oleate in the Presence of Oleic Acid (Sample 11)

Iron oleate (0.100 g, 0.12 mmol, 0.24 mmol (Fe)), oleic acid (0.435 g, 1.54 mmol) and icosane (0.60 g) were combined in a three-necked flask, which was equipped with a reflux condenser and a temperature sensor immersed in the reaction mixture. The mixture was heated to 360° C. with a heating rate of 3.3° C./min and kept at that temperature for 2 hours. After cooling to 50° C., hexane (10 ml) was added to obtain a homogenous solution. Next, acetone (20 ml) was added to initiate precipitation of the formed solids, which were collected upon centrifugation (4900 rpm, 30 min) and decantation. For washing purposes, the collected solid material was resuspended in hexane (5 ml) precipitated by the addition of acetone (10 ml), centrifuged and collected as described above. The washing procedure was repeated once more, whereupon the collected solids were suspended in hexane to yield a stable black solution of iron oxide nanoparticles. Subsequently, the iron oxide nanoparticles obtained in Example 2 were characterized by magnetic particle spectroscopy (MPS).

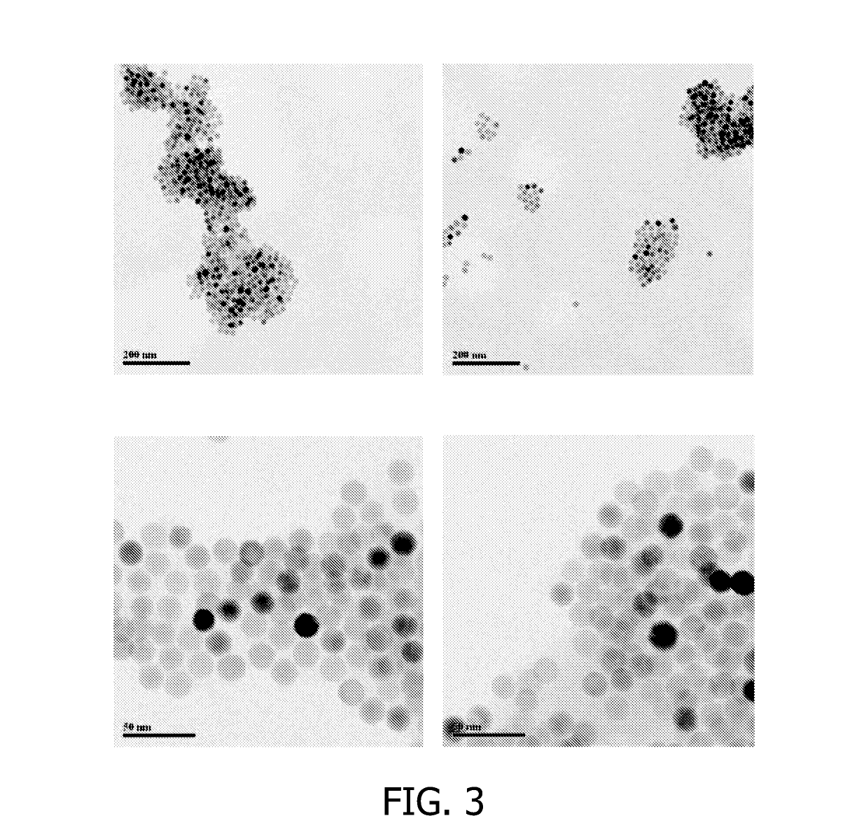

As depicted in FIG. 3, iron oxide nanoparticles obtained in Example 2 have an average particle size of about 18 nm.

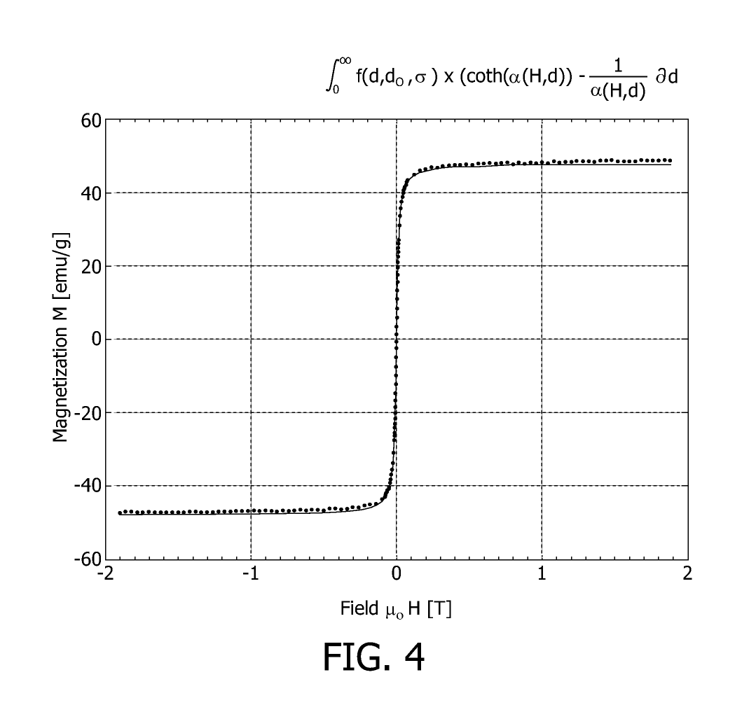

As can be derived from FIG. 4, the saturation magnetization of sample 11 was 47.9 emu/g, which is consistent with a composition of the magnetic core of the particles of approximately Fe₃O₄.

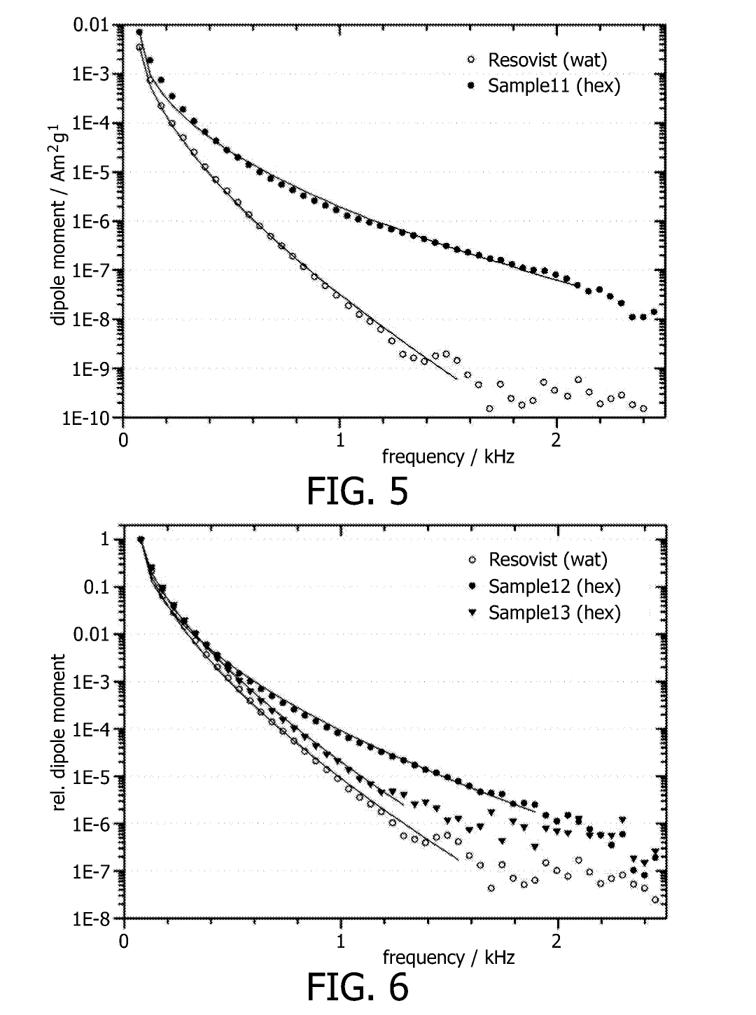

As can be derived from FIG. 5, the MPS signal intensity of sample 11 was significantly higher over the entire frequency range compared to that of a Resovist® sample measured under identical conditions. Resovist® is the accepted gold standard for MPS measurements.

### Example 3

### Thermal Decomposition of Sodium Oleate in the Presence of Oleic Acid (Sample 12)

Iron oleate (0.100 g, 0.12 mmol, 0.24 mmol (Fe)), oleic acid (0.684 g, 2.42 mmol) and icosane (0.60 g) were combined and treated as described in Example 2. Iron oxide nanoparticles were obtained as described in Example 2 and characterized by magnetic particle spectroscopy (MPS).

As can be derived from FIG. 6, the MPS signal intensity of sample 12 was significantly higher over the entire frequency range compared to that of a Resovist® sample measured under identical conditions. Resovist® is the accepted gold standard for MPS measurements.

### Example 4

### Thermal Decomposition of Sodium Oleate in the Presence of Oleic Acid (Sample 13)

Iron oleate (0.100 g, 0.12 mmol, 0.24 mmol (Fe)), oleic acid (0.560 g, 1.98 mmol) and icosane (0.60 g) were combined and treated as described in Example 2. Iron oxide nanoparticles were obtained as described in Example 2 and characterized by magnetic particle spectroscopy (MPS).

As can be derived from FIG. 6, the MPS signal intensity of sample 13 was significantly higher over the entire frequency range compared to that of a Resovist® sample measured under identical conditions. Resovist® is the accepted gold standard for MPS measurements. Nevertheless sample 13 compared inferior to sample 12 using this criterion.

1. A method of forming an iron oleate complex comprising the steps of:
(a) dissolving an oleate in a low-order alcohol solvent selected from the group of methanol butanol, glycol, acetone, ethyleneglycol, 2-aminoethanol, 2-methoxyethanol, dimethylformamide and dimethylsulfoxide at a temperature of about 35° C. to 65° C.;
(b) adding a non-polar alkane solvent to the solution of step (a);
(c) adding an iron salt dissolved in said low-order alcohol solvent to the solution of step (b);
(d) agitating the solution of step (c) at a temperature of about 50° C. for at least 5 min;
(e) cooling the reaction mixture of step (d) to a temperature of about 15° C. to 30° C.;
(f) optionally filtering the reaction mixture of step (e);
(g) separating said non-polar solvent phase from the low-order alcohol solvent phase;
(h) washing and drying the non-polar solvent phase;
(i) removing volatiles from the non-polar solvent of step (h) by evaporation; and
(j) mixing the product of step (i) with a polar solvent to yield a solid iron oleate complex.

2. The method of claim 1, wherein the temperature of dissolving step (a) is at about 50° C.

3. The method of claim 1, wherein said oleate is sodium oleate, and/or wherein said low-order alcohol solvent is methanol, and/or wherein said non-polar solvent is hexane, and/or wherein said polar solvent is acetone, and/or wherein said iron salt is iron chloride, preferably iron(III) chloride (FeCl₃).

4. The method of claim 3, wherein an excess of sodium oleate is used.

5. The method of claim 4, wherein a sodium oleate:FeCl₃ molar ratio of 3:1 is used.

6. The method of claim 1, wherein mixing step (j) is carried out for about 1 to 10 h.

7. The method of claim 1, wherein one or more of the additional steps
(k) isolating the solid iron oleate complex by filtration;
(l) washing the solid iron oleate complex of step (j) or (k) with a polar solvent;
(m) dissolving the solid iron oleate complex of step (l) in a non-polar solvent;
(n) filtering the solid iron oleate complex of step (m);
(o) adding to the solid iron oleate complex of step (n) an excess of a polar solvent;
(p) stirring the suspension of step (o) for about 1 to 10 h;
(q) filtering the iron oleate complex;
(r) washing the iron oleate complex of step (q) with a polar solvent; and
(s) drying the iron oleate complex of Step® to yield a powdery solid iron oleate complex,
is performed.

8. The method of any one of claim 7, wherein in step (o) an excess of acetone of at least 4:1 is added.

9. An iron oleate complex obtainable by a method according to claim 1.

10. An iron oleate complex of formula: 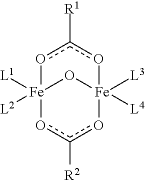
wherein R¹ and R² is (CH₂)₇(CH)=(CH)(CH₂)₇CH₃ and L¹, L², L³ and L⁴ are auxiliary ligands.

11. The iron oleate complex of claim 10, wherein said auxiliary ligands L¹ and L² are independent of each other acetone, methanol, ethanol, water, tetrahydrofurane, imidazole, methylimidazole, pyridine, formamide, dimethylformamide, pyrolidon, 1-methyl-2-pyrolidon, hydroxide, fluoride, chloride, bromide, iodide, sulfate, bisulfate, phosphate, biphosphate, nitrate, sulfide, bisulfide, oxalate, lactate, cyanide, cyanate, isocyanate, thiocyanate, isothiocyanate, acetylacetonate, carbonate, bicarbonate, azide, benzoate, acrylate, methacrylate, sulfite, bisulfite, methoxide, ethoxide, cyclohexanesulfonate, methanesulfonate, ethanesulfonate, propanesulfonate, pentanesulfonate, hexanesulfonate, octanesulfonate, decanesulfonate, dodecanesulfonate, octadecanesulfonate, citrate, tartrate, borate, hydrogen borate, dihydrogen borate, nitrite, perborate, peroxide, thiosulfate, methionate, acetate, propionate, butyrate, pentanoate, hexanoate, heptanoate, octanoate, decanoate, dodecanoate, pentadecanoate, hexadecanoate, octadecanoate, or oleate.

12. The iron oleate complex of claim 10, wherein said complex has the molecular formula Fe₂O(oa)₂(OH)₂(OC(CH₃)₂)₂.

13. Use of the iron oleate complex, or the iron oleate complex obtainable by a method according to claim 1, as precursor for the preparation of nanoparticles.

14. A method of forming iron oxide nanoparticles comprising the steps of:
(a) suspending oleic acid and the iron oleate complex, or the iron oleate complex obtainable by a method according to claim 1 and optionally oleylamine, in a primary organic solvent;
(b) increasing the temperature of the suspension by a defined rate up to a maximum of 340° C. to 500° C.;
(c) aging the suspension at the maximum temperature of step (b) for about 0.5 to 6 h;
(d) cooling the suspension;
(e) adding a secondary organic solvent;
(f) precipitating nanoparticles by adding a non-solvent and removing excess solvent;
(g) dispersing said nanoparticles in said secondary organic solvent;
(h) mixing the dispersion of step (g) with a solution of a polymer; and
(i) optionally removing said secondary organic solvent.

15. The method of claim 14, wherein one or more of the additional steps
(j) purifying the nanoparticle or nanoparticle solution obtainable in step (i);
(k) treating the nanoparticle or nanoparticle solution obtainable in step (i) or (j) with an oxidizing or reducing agent;
(l) modifying the surface of the nanoparticle obtainable in step (i) or (j) by removing, replacing or altering the coating;
(m) encapsulating or clustering the nanoparticle obtainable in step (i) to (l) with a carrier such as a micelle, a liposome, a polymersome, a blood cell, a polymer capsule, a dendrimer, a polymer, or a hydrogel; and
(n) decorating the nanoparticle obtainable in step (i) to (m) with a targeting ligand,
is performed.

16. The method of claim 1, wherein said oleate is sodium oleate, and wherein said low-order alcohol solvent is methanol, and wherein said non-polar solvent is hexane, and wherein said polar solvent is acetone, and wherein said iron salt is iron(III) chloride (FeCl₃).
